(19) United States
(12) Patent Application Publication
(10) Pub. No.: US 2007/0160880 A1
(43) Pub. Date: Jul. 12, 2007

(54) Fuel-staged hydrocarbon reformer system

(76) Inventor: Bernhard A. Fischer, Rochester, NY (US)

Correspondence Address: DELPHI TECHNOLOGIES, INC., M/C 480-410-202, PO BOX 5052, TROY, MI, 48007, US

(21) Appl. No.: 11/327,867

(22) Filed: Jan. 9, 2006

(51) Int. Cl. H01M 8/06; H01M 8/04; B01J 8/04; C01B 3/26

(52) U.S. Cl. 429/19; 422/189; 422/198; 429/17; 423/652

(57) ABSTRACT

A two-stage hydrocarbon reformer system for supplying reformate to a fuel cell stack. The system comprises first and second catalytic reformers arranged in flow series. The first reformer is an adiabatic reactor supplied with hydrocarbon fuel and air, as is well known in the reforming arts. The second reformer is a heated reactor supplied with reformate from the first reactor, plus additional hydrocarbon fuel and recycled anode tail gas, which preferably are mixed before entering the second reactor. In a second embodiment, the first reformer is also supplied with recycled anode tail gas. In a third embodiment, the reactants for at least one of the reformers are preheated before being admitted to the reformer; and in a fourth embodiment, the reactants for both reformers are preheated. In a fifth embodiment, one or both reformers are provided with water for steam reforming in the second reformer.

The present invention relates to hydrocarbon reformers for producing fuel for fuel cells; more particularly, to such a reformer that utilizes the anode tail gas stream from an associated fuel cell system; and most particularly, to such a reformer having two sequential reforming stages wherein hydrocarbon fuel is supplied to both stages.

### BACKGROUND OF THE INVENTION

Partial catalytic oxidizing (CPOx) reformers are well known in the art as devices for converting hydrocarbons to reformate containing hydrogen (H₂) and carbon monoxide (CO) as fuel for fuel cell systems, and especially for solid oxide fuel cell (SOFC) systems. CPOx reformers of hydrocarbon fuels are limited by physics and chemistry to a maximum efficiency of 75% to 85%. The invention herein describes a fuel reformer as well as a means of system start-up, system heat-up, and system operation over the entire operating range with efficiencies much surpassing that of simple CPOx reformers.

Traditional CPOx reformers operate by mixing hydrocarbon fuels and oxygen (air) prior to the reforming catalyst. The oxygen in the mixture reacts in an initial, fast, exothermic reaction with parts of the hydrocarbon fuel to provide the heat and the reforming agents (H₂O and CO₂) for the subsequent endothermic hydrogen and carbon monoxide producing reforming kinetics. CPOx reformers are typically adiabatic in nature, meaning no heat is added in addition to the exothermic reaction heat release. While such reformers offer relative simple designs and operation, start-up capability and system warm-up with few complications, they cannot provide the high efficiencies required for modern fuel cell designs.

In a typical SOFC fuel cell system, the anode tail gas stream exiting the fuel cell stack is typically rich in H₂O, CO₂, and also a substantial amount of residual hydrogen. Venting or burning the anode tail gas is wasteful and directly affects fuel efficiency of the fuel cell system. To increase the overall fuel efficiency, it is known in the art to recycle a portion of the anode tail gas back into the reformer, which improves efficiency in three ways: a) by passing the residual hydrogen through the stack again, b) by providing beneficial heat from the stack to the reformer, and c) by providing the fuel reforming agents H₂O and CO₂ to the reactor to reform the hydrocarbon fuel at minimum air (molecular oxygen) requirement.

Recycling anode tail gas allows apparent reformer efficiencies in excess of 100%. Nonetheless, tests with an adiabatic methane reformer supplied with tail gas have shown that reforming efficiencies of 125% to 130% can be achieved only with high amounts of recycle, in the range of 45% to 60%, and only with substantial preheating of the reactants. In addition, the residual methane percentage in the reformate, known in the art as “methane and fuel breakthrough”, might far exceed a desirable limit of about 1%. Further, a desirable ratio of water to methane greater than 3 cannot be achieved with a prior art recycling reformer due to the high methane breakthrough rendering the design vulnerable to carbon formation and deposition. Finally, the thermal balance of the CPOx reactor at high recycle rates requires the injection of large amounts of air (molecular oxygen) which leads to a substantial dilution of hydrogen and carbon monoxide in the reformate and a decrease in fuel cell electrochemistry.

Even with a heat exchange reheating catalyst between the reformer and the stack, recycle rates of 57% are required to meet efficiency goals with no preheating of reactants for Methane fuel. Further, mixing the recycle into the reformate being discharged from the reformer and then passing the mixture through a reheat catalyst does not serve to achieve high fuel efficiency.

In any known prior art scheme wherein all of the oxidizing air required for adiabatic reforming is injected into the CPOx reformer itself, without preheating the reactants to near fuel reforming temperatures of around 800° C., the thermodynamic balance of the reforming reactor requires large amounts of air to supply the heat and reforming agents H₂O and CO₂.

The increased amounts of air elevates the oxygen/carbon ratio to such an extent that high reforming efficiencies cannot be achieved. In other words, the desired thermal efficiencies cannot be achieved in part because of the large amount of nitrogen present in air that has to be heated, and in part because of the oxidation of large amounts of fuel into water and CO₂.

What is needed is a means for increasing the reforming efficiency of an adiabatic hydrocarbon reformer and the overall fuel efficiency of an SOFC fuel cell system.

It is a principal object of the present invention to increase the reforming efficiency of a hydrocarbon reformer while maintaining system operability.

### SUMMARY OF THE INVENTION

The invention describes a reforming strategy as well as a fuel cell operating strategy for gaseous and liquid hydrocarbon fuels. The reformer sub-system allows for initial ignition and start-up, heat-up of the fuel cell system, and all fuel cell operation from idle to peak power while providing highest efficiency when needed without damaging delicate components during acceleration, turndown, or shutdown.

Briefly described, in a first embodiment, a hydrocarbon reformer system for supplying reformate to a fuel cell stack comprises first and second catalytic reactors arranged in flow series. The first reactor is an adiabatic CPOx reactor supplied with hydrocarbon fuel and air, as is well known in the reforming arts. Anode exhaust gas (recycle) may be injected into the fuel and air to the first reactor for liquid fuels and some cases of gaseous fuels to prevent flashback and autoignition. The second reactor is a heated reactor supplied with effluent (reformate) from the first reactor, plus additional hydrocarbon fuel and recycled anode tail gas, which are mixed before entering the second reactor.

In a second embodiment, the second reactor is supplied with recycled anode tail gas.

In a third embodiment, both the first and second reactors are supplied with recycled anode tail gas.

In a fourth embodiment, the reactants for at least one of the reactors are preheated before being admitted to the reformer; and in a fifth embodiment, water is added to the recycled anode tail gas supplied to the second reactor. A combustor and heat exchanger may also be added to the second reactor to increase efficiencies.

A method, in accordance with the invention, provides the system's reformate needs from ignition, through start-up, to idle and acceleration, and across all operating and load conditions. In the preferred embodiment. ignition, start-up and system heat-up occurs entirely within the primary CPOx reactor. During these conditions, all the fuel and air will go to the primary reactor. When recycled tail gas becomes available during system warm-up, recycled tail gas is introduced into the primary reactor and after the primary reactor. At a later stage when the system is at operating condition, increased amounts of fuel and recycled tail gas are provided to the second reactor to increase efficiency and to maintain operability. Finally, and for the highest efficiency, all fuel and recycled tail gas is shut off to the primary reactor; fuel, recycled tail gas and air are supplied only to the second reactor.

### BRIEF DESCRIPTION OF THE DRAWINGS

The present invention will now be described, by way of example, with reference to the accompanying drawings, in which:

FIG. 1 is a schematic drawing of a prior art single-stage adiabatic reformer system, showing recycle ingestion;

FIG. 2 is a schematic drawing of a prior art two-stage reformer system, showing fuel, air, and recycle ingestion in the first stage only;

FIG. 3 is a schematic drawing of a prior art two-stage reformer system, showing fuel and air ingestion in the first stage only, and recycle ingestion in the second stage only;

FIG. 4 is a schematic drawing of a first embodiment of a two-stage reformer system in accordance with the invention, showing primary fuel, air and recycle ingestion in the first stage, and secondary fuel ingestion in the second stage;

FIG. 5 is a schematic drawing of a second embodiment, showing primary fuel and air ingestion in the first stage, and secondary fuel and recycle ingestion in the second stage;

FIG. 6 is a schematic drawing of a third embodiment, showing primary fuel, primary recycle, and air ingestion in the first stage, and secondary fuel and secondary recycle ingestion in the second stage;

FIG. 7 is a schematic drawing of a fourth and currently-preferred embodiment which is similar to the first embodiment shown in FIG. 4 but wherein the reactants for both stages are preheated;

FIG. 8 is a graph of gross reformer efficiency for each of the arrangements shown in FIGS. 1 through 6, wherein percent reforming efficiency is expressed as a function of percentage of anode tail gas recycled;

FIG. 9 is a graph of methane breakthrough for each of the arrangements shown in FIGS. 1 through 6, wherein mole percent methane is expressed as a function of percentage of anode tail gas recycled;

FIG. 10 is a graph of carbon formation temperature for each of the arrangements shown in FIGS. 1 through 6, wherein the carbon formation temperature is expressed as a function of percentage of anode tail gas recycled;

FIG. 11 is a graph of hydrogen dilution for each of the arrangements shown in FIGS. 1 through 6, wherein the mole percent hydrogen in the reformate is expressed as a function of percentage of anode tail gas recycled;

FIG. 12 is a graph of carbon monoxide dilution for each of the arrangements shown in FIGS. 1 through 6, wherein the mole percent carbon monoxide in the reformate is expressed as a function of percentage of anode tail gas recycled; and

FIG. 13 is a schematic drawing of a fifth embodiment showing use of the secondary reformer as a main steam reformer.

### DESCRIPTION OF THE PREFERRED EMBODIMENTS

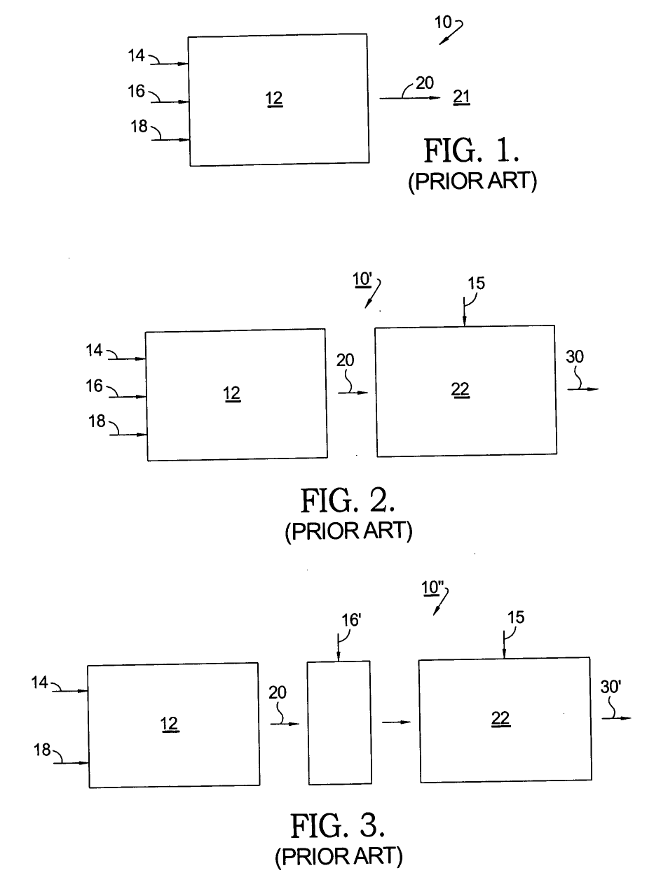

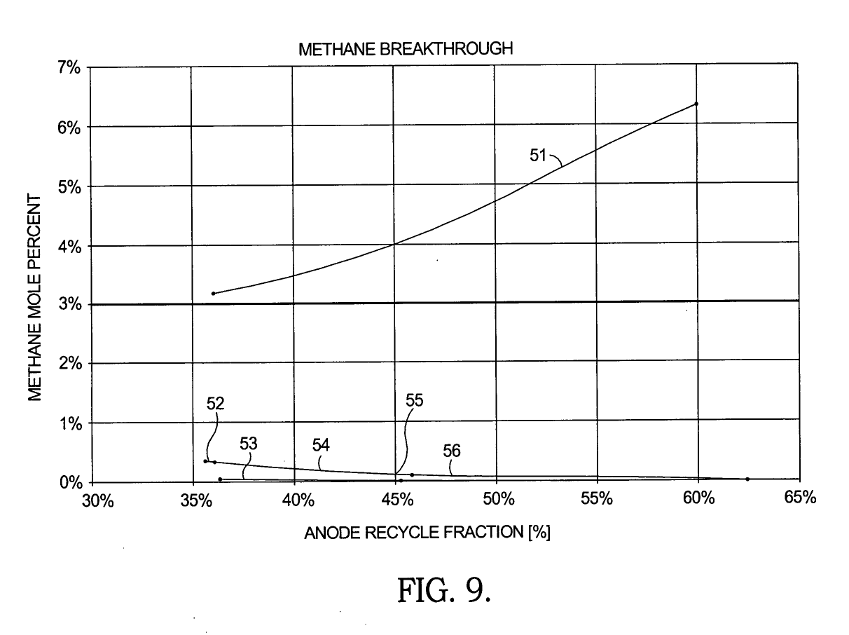

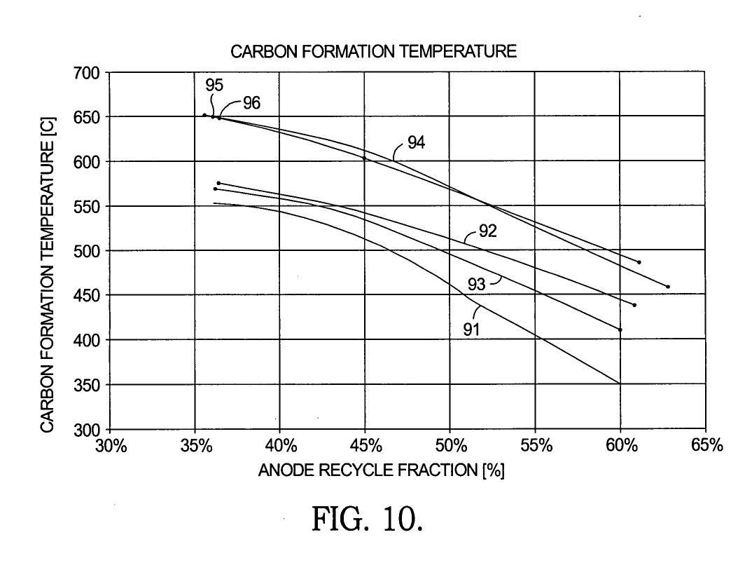

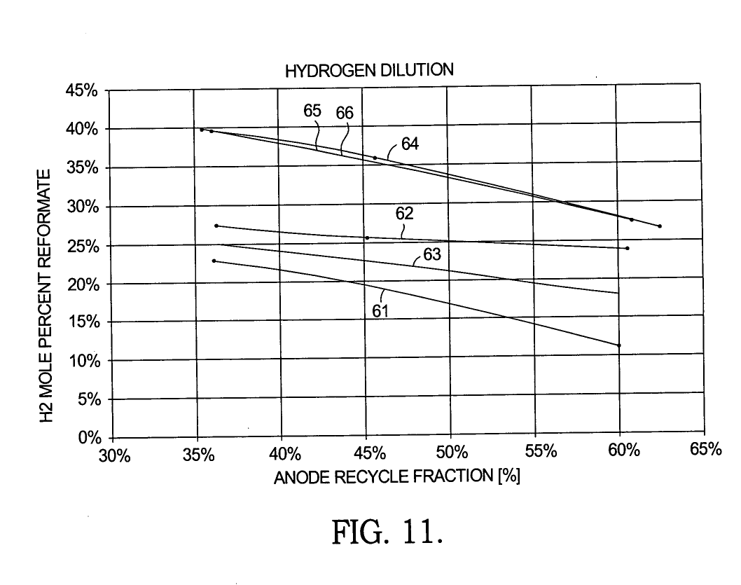

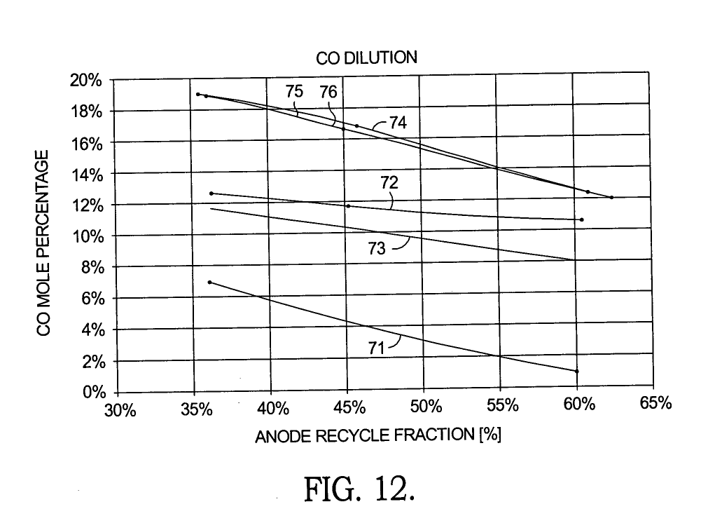

Referring to FIGS. 1 and 8-12, in a first prior art single-stage adiabatic reformer system 10, an adiabatic catalytic reactor 12 is supplied with flows of hydrocarbon fuel 14, and oxygen 18, and generates a first reformate 20 for use in a fuel cell system 21, for example, a solid-oxide fuel cell system. Optionally, recycled anode tail gas 16 may be injected into the fuel and air to the reactor for liquid fuels and some cases gaseous fuel to prevent flashbacks and auto-ignition. At a tail gas recycle 16 of 35% or greater, reformate 20 comprises greater than 3% methane breakthrough (FIG. 9 curve 51), less than 25% hydrogen (FIG. 11 curve 61), and less than 8% carbon monoxide (FIG. 12 curve 71). Although carbon formation temperature is low (FIG. 10 curve 91), because nitrogen dilution increases, gross reformer efficiency is only between 95% and 105% (FIG. 8 curve 81).

Referring to FIGS. 2 and 8-12, in a prior art two-stage reformer system 10′, a primary adiabatic catalytic reactor 12 is supplied with flows of primary fuel 14, primary anode tail gas recycle 16, and oxygen 18, and generates a first reformate 20, as in the single-stage system 10 shown in FIG. 1. A secondary heated reheat catalytic reactor 22 is supplied with heat 15 and with first reformate 20 and produces a secondary reformate 30. At a primary tail gas recycle flow of 35% or greater, secondary reformate 30 exhibits no measurable methane breakthrough (FIG. 9 curve 52); greater than 25% hydrogen content (FIG. 11 curve 62); a somewhat elevated carbon formation temperature due to the higher efficiency (FIG. 10 curve 92); and significantly greater carbon monoxide content (FIG. 12 curve 72). However, to achieve gross reformer efficiencies in the range of 125%-130% requires primary recycle flows in the range of 55%-60% (FIG. 8 curve 82), which causes undesirable dilutions of hydrogen and carbon monoxide in secondary reformate 30 which are not completely offset by methane catalysis in the secondary reactor.

Referring to FIGS. 3 and 8-12, in another prior art two-stage reformer system 10″ similar to system 10′, secondary anode tail gas recycle 16′ (there is no primary anode tail gas recycle in this embodiment) is mixed with first/primary reformate 20 just ahead of secondary reactor 22, which produces a secondary reformate 30′. At a secondary tail gas recycle 16′ flow of 35% or greater, secondary reformate 30′ exhibits no measurable methane breakthrough (FIG. 9 curve 53) but inferior hydrogen content (FIG. 11 curve 63), inferior carbon monoxide content (FIG. 12 curve 73), inferior carbon formation temperatures (FIG. 10 curve 93), and inferior gross reformer efficiencies (FIG. 8 curve 83) when compared to two-stage system 10′ which uses primary tail gas recycle 16 (Curve 82).

It is clear from the above results that providing a secondary reheat reactor 22 to a) clean up breakthrough methane in primary reformate 20 and/or to b) gain reforming efficiency through tail gas recycle is not justifiable and in fact is counterproductive in terms of the quality of secondary reformate 30,30′ available for fueling an SOFC stack. Methane is fully catalyzed but at the expense of hydrogen and carbon monoxide fuel content because of the dilutive effect of the recycled tail gas. What is needed in using a secondary reactor in series with a primary adiabatic reactor is means for compensating for the dilutive effect of anode tail gas.

Anode tail gas is rich in both water and carbon dioxide which can be catalytically decomposed to hydrogen and carbon monoxide (and trace amounts of carbon dioxide and water), at elevated temperature, and in the presence of fuel, in accordance with the following equation:
H₂O+CO₂+heat→H₂+CO+H₂O+CO₂ (Eq. 1)

In accordance with the present invention, an additional, secondary flow of hydrocarbon fuel and heat is introduced into the secondary reactor. Unlike in the primary reactor, no elemental oxygen (in the form of air) is supplied for reforming to the secondary reactor. Thus, the reformate provided from the secondary reactor is a) enriched in hydrogen, b) enriched in carbon monoxide, c) depleted in methane, and d) depleted in oxygen with respect to prior art reformates, all of which represent improvements over the prior art.

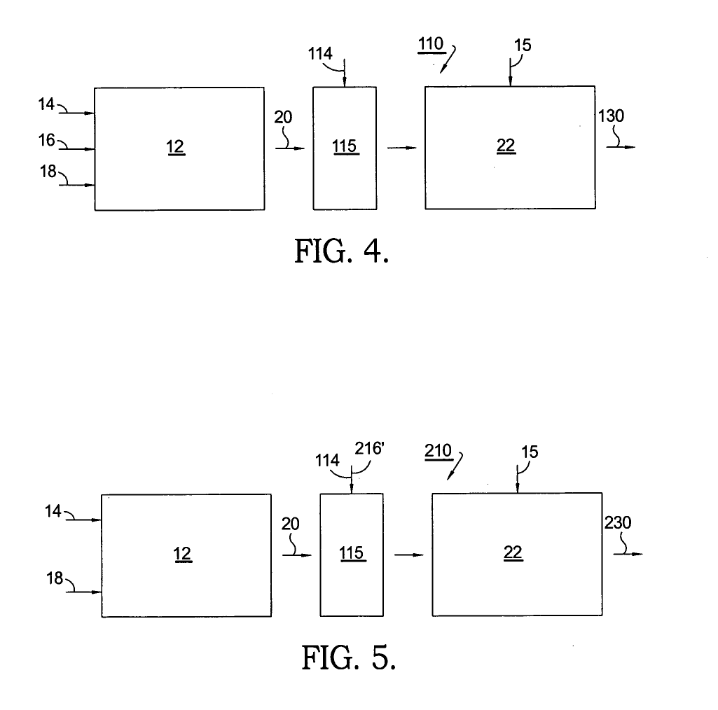

Referring to FIGS. 4 and 8-12, a first embodiment 110 of a two-stage reformer system in accordance with the invention is similar in components to second prior art embodiment 10′ shown in FIG. 2, with the following important distinction and improvement. A secondary flow 114 of hydrocarbon fuel is provided to secondary reactor 22 in addition to the flow of reformate 20 from first reactor 20 to generate an improved secondary reformate 130. Preferably, flow 114 and reformate 20 are mixed via a fuel receiver such as, for example, a static mixer 115 in known fashion prior to being introduced into secondary reactor 22.

The benefits of providing secondary fuel flow 114 to secondary reactor 22 are surprisingly great. Referring to FIGS. 8 through 12, it is seen that reforming efficiency (FIG. 8, Curve 84) is greater than for any of the three prior art arrangements at all recycle flow values less than 55%; methane breakthrough (FIG. 9, Curve 54) is less than 0.5%; the carbon formation temperature is elevated (FIG. 10, Curve 94); hydrogen is enriched by about 30% (FIG. 11, Curve 64); and carbon monoxide is enriched by 30-50% (FIG. 12, Curve 74).

Referring to FIGS. 5 and 8-12, in a second embodiment 210 of a two-stage reforming system in accordance with the invention, anode tail gas recycle may be introduced as a secondary recycle 216′ as in prior art embodiment 10″, along with secondary fuel 114 instead of as primary recycle as shown in embodiment 110.

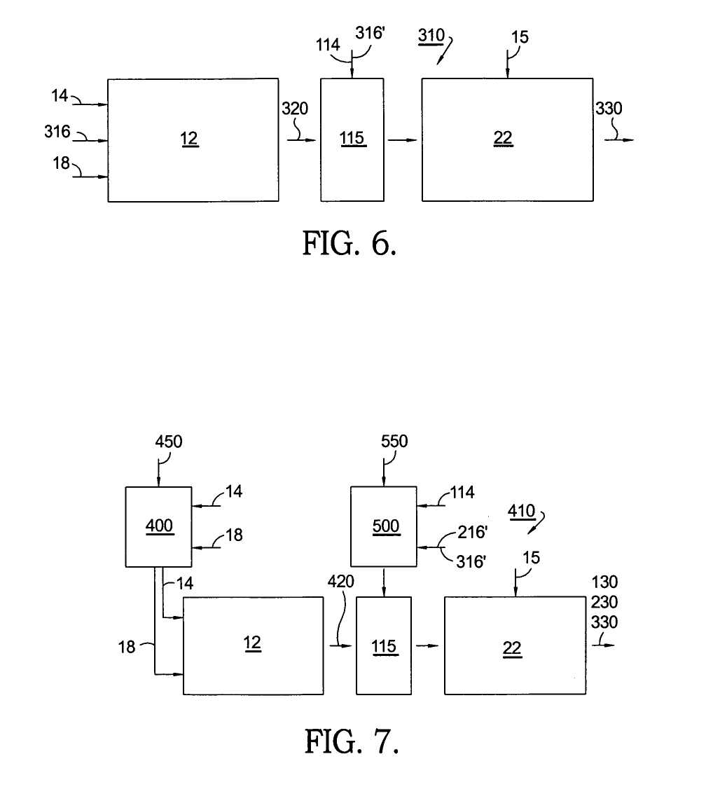

Referring to FIG. 6, in a third embodiment 310 of a two-stage reforming system in accordance with the invention, anode tail gas recycle may be introduced both as a primary recycle 316a and as a secondary recycle 316′, yielding primary reformate 320 and secondary reformate 330.

The results obtained with embodiments 210 and 310 shown in FIGS. 5 and 6 are comparable to those obtained with embodiment 110, shown in FIG. 4. In all three embodiments, reforming efficiency (Curves 84,85,86) is improved at all recycle flow values less than 55%; methane breakthrough (Curves 54,55,56) is negligible; carbon formation temperature is elevated (Curves 94,95,96); and hydrogen (Curves 64,65,66) and carbon monoxide (Curves 74,75,76) are significantly enriched.

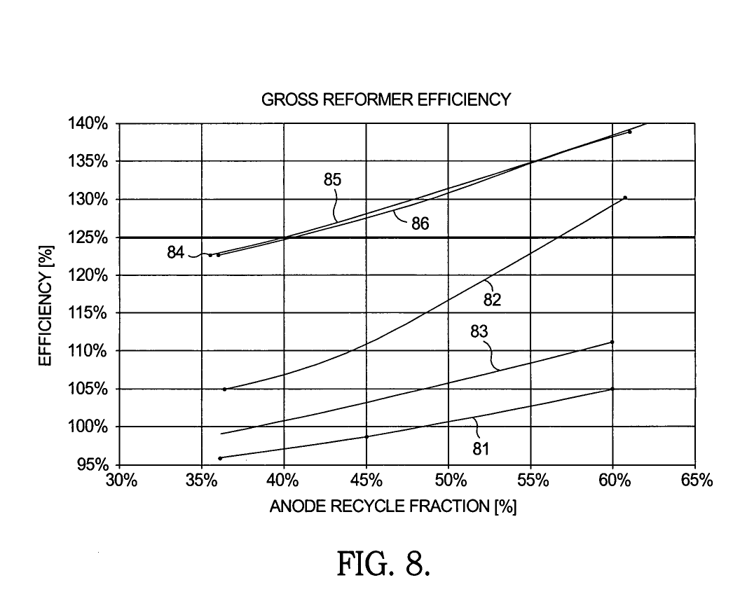

Referring to FIG. 7, for thermodynamic reasons, in a fourth embodiment 410, the composition of any of secondary reformates 130,230,330 generated by any of embodiments 110,210,310 may be further enhanced by preheating reactants 14, 18 by a preheating source 400, as known in the art, (heat 450) supplied to the primary reactor 12 and/or by preheating reactants 114, 216′, 316′ by a preheating source 500, as known in the art, (heat 550) supplied to secondary reactor 22.

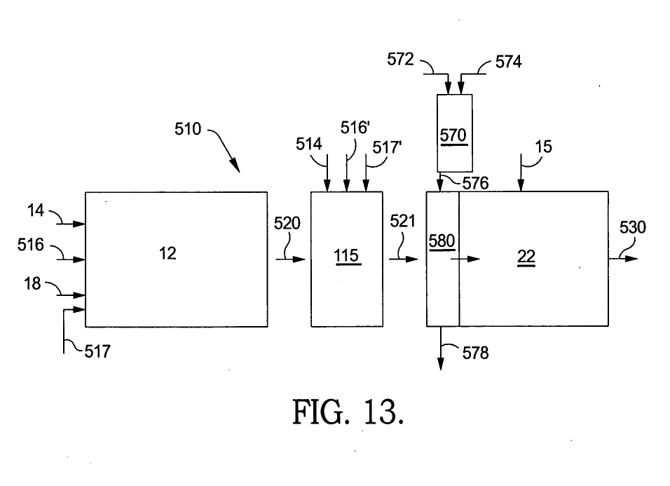

Referring to FIG. 13, in a fifth embodiment 510, primary reformer 12 is supplied with all the oxygen 18 required for reforming, but with only enough fuel 14 and primary recycle 516 to achieve the desired temperature within the reformer. In general, the less fuel provided, the higher the efficiency. Preferably, a small amount of water or steam 517 is added to prevent carbon formation. Primary reformate 520 is mixed 115 with secondary fuel 514 and secondary recycle 516′. In this embodiment, the preponderance of reforming occurs in secondary reformer 22, and fuel 514 is the preponderance of fuel, yielding a secondary reformate 530. To augment the water contained in recycle 516′ commensurate with the high fuel load, additional water 517′ must be added to the fuel mixture 521 for secondary reformer 22. To assure adequate temperatures are provided for endothermic reforming (“steam reforming”) in secondary reformer 22, a portion 572 of the anode tail gas stream is combusted in a low-emissions combustor 570, which may also be augmented by a low level of hydrocarbon fuel 574 and air as needed. The hot combustor exhaust 576 is passed through one side of a preheating heat exchanger 580 and exhausted 578. Mixture 521 is passed through the opposite side of exchanger 580, thereby assuring, in addition to heat 15, sufficient heat in secondary reformer 22 to carry out endothermic reforming of fuel 514 plus any methane from primary reformer 12.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A multiple-stage reformer system comprising:
a) a primary catalytic reformer for receiving a primary flow of hydrocarbon fuel and a flow of oxygen for producing a primary reformate;
b) a secondary catalytic reformer fluidly connected to said primary catalytic reformer for receiving said primary reformate; and
c) a fuel receiver for entering a secondary flow of hydrocarbon fuel into said secondary catalytic reformer,
wherein said primary reformate and said secondary flow of hydrocarbon fuel are acted upon by said secondary catalytic reformer to produce a secondary reformate.

2. A multiple-stage reformer system in accordance with claim 1 further comprising a flow of anode tail gas from a fuel cell stack into one of said primary catalytic reformer or said secondary catalytic reformer.

3. A multiple-stage reformer system comprising a flow of anode tail gas from a fuel cell stack into said secondary catalytic reformer in accordance with claim 2 and further comprising a mixer for mixing said primary reformate and said flow of anode tail gas ahead of said secondary catalytic reformer.

4. A multiple-stage reformer system in accordance with claim 2 wherein said fuel cell stack is supplied with said secondary reformate.

5. A multiple-stage reformer system in accordance with claim 2 wherein the volume of said stream of anode tail gas is up to about 70% of the total volume of said anode tail gas stream.

6. A multiple-stage reformer system in accordance with claim 1 comprising a flow of anode tail gas from a fuel cell stack into said primary catalytic reformer and a flow of anode tail gas from a fuel cell stack into said secondary catalytic reformer.

7. A multiple-stage reformer system in accordance with claim 1 wherein said primary catalytic reformer is an exothermic adiabatic reformer.

8. A multiple-stage reformer system in accordance with claim 1 wherein said secondary catalytic reformer is an endothermic heated reformer.

9. A multiple-stage reformer system in accordance with claim 6 wherein water is added to said secondary catalytic reformer.

10. A multiple-stage reformer system in accordance with claim 6 wherein water is added to said primary catalytic reformer.

11. A multiple-stage reformer system in accordance with claim 1 further comprising a heater for heating reactants before entering one of said primary catalytic converter or said secondary catalytic converter.

12. A multiple-stage reformer system in accordance with claim 1 further comprising a heater for heating reactants before entering both of said primary and secondary catalytic converters.

13. A fuel cell system, comprising a multiple-stage reformer system for catalytically converting hydrocarbon fuel into reformate containing molecular hydrogen and carbon monoxide for fueling a stack in said fuel cell system, said reformer system including,
a primary catalytic reformer for receiving a primary flow of hydrocarbon fuel and a flow of oxygen for producing a primary reformate,
a secondary catalytic reformer fluidly connected to said primary catalytic reformer for receiving said primary reformate, and
a fuel receiver for entering a secondary flow of hydrocarbon fuel into said secondary catalytic reformer,
wherein said primary reformate and said secondary flow of hydrocarbon fuel are acted upon by said secondary catalytic reformer to produce a secondary reformate for fueling said fuel.

14. A fuel cell system in accordance with claim 13 wherein said multiple-stage reformer system further includes a flow of anode tail gas from said fuel cell stack into one of said primary catalytic reformer or said secondary catalytic reformer.

15. A method for making reformate containing hydrogen and carbon monoxide by partial catalytic oxidation of hydrocarbon fuel, comprising the steps of:
a) providing a primary catalytic reformer and a secondary catalytic reformer;
b) supplying a primary flow of said hydrocarbon fuel and a flow of oxygen to said primary catalytic reformer;
c) supplying a primary reformate from said primary catalytic reformer to said secondary catalytic reformer;
d) supplying a secondary flow of said hydrocarbon fuel to said secondary catalytic reformer; and
e) catalytically reacting said primary reformate and said secondary flow of hydrocarbon in said secondary catalytic reformer to produce a flow of secondary reformate.

16. A method in accordance with claim 15 comprising the further step of supplying anode tail gas to at least one of said primary and secondary catalytic reformers.

17. A method in accordance with claim 15 comprising the further step of preheating process reactants before supplying said process reactants to at least one of said primary and secondary catalytic reformers.

18. A method in accordance with claim 15 comprising the further step of adding water to at least one of said primary and secondary catalytic reformers.

19. A method for operating a multi-stage reformer system having first catalytic reformer in flow communication with a second catalytic reformer for supplying reformate to a fuel cell stack, said method comprising the steps of:
a) supplying a primary flow of hydrocarbon fuel and a flow of oxygen to said first reformer to produce a first reformate;
b) supplying a flow of said first reformate to said fuel cell stack;
c) supplying an anode tail gas from said fuel cell stack to said first reformer and said second reformer and supplying a secondary flow of hydrocarbon fuel to said second reformer to produce a second reformate;
d) supplying a flow of said second reformate to said fuel cell stack.

20. The method in accordance with claim 19 further comprising the steps of decreasing the primary flow of hydrocarbon fuel and anode tail gas to said first reformer and increasing the secondary flow of hydrocarbon fuel and anode tail gas to said second reformer.

21. The method in accordance with claim 19 further comprising the steps of shutting off the primary flow of hydrocarbon fuel and anode tail gas to said first reformer.
